(19) United States
(12) Patent Application Publication
(10) Pub. No.: US 2026/0252580 A1
(43) Pub. Date: Aug. 27, 2026

(54) Adaptive Data Ingestion and Mapping (ADIM) in Dynamic Decision Systems

(71) Applicant: AtlasVision, Inc., New York, NY (US)

(72) Inventors: Konstantin Bokarius, South Lake Tahoe, CA (US); Constantine Nicolaidis, New York, NY (US); Leonard Crosson, Hatfield, PA (US)

(21) Appl. No.: 19/547,680

(22) Filed: Feb. 24, 2026

Related U.S. Application Data
(60) Provisional application No. 63/764,464, filed on Feb. 27, 2025.

(51) Int. Cl. G06F 16/25; G06F 16/2452; G06F 16/901; G06F 40/30

(52) U.S. Cl. CPC G06F 16/254; G06F 16/24528; G06F 16/9024; G06F 40/30

(57) ABSTRACT

A processing configuration for adaptive data ingestion and mapping receives and parses data from heterogeneous sources without requiring predefined schemas, processing structured, semi-structured, and unstructured formats. The configuration identifies entities, attributes, and relationships within parsed data and aligns them with an ontological structure using rule-based processing, machine learning, and natural language processing to resolve semantic variations. The aligned data is refined and standardized based on historical patterns, domain-specific rules, and real-time operational context, with transformations adjusted dynamically in response to data changes. Changes in incoming data are detected and differential updates are applied to previously processed data, modifying only affected portions while maintaining computational efficiency. Normalized data is organized into a graph format establishing contextual relationships between entities, and these relationships are mapped to visualization elements for presentation to decision-support systems.

### CROSS REFERENCE TO RELATED APPLICATIONS

The present application claims the benefit of, and priority to, U.S. Provisional Application No. 63/764,464, filed February 27, 2025, the disclosure which is herein incorporated by reference in its entirety.

### FIELD OF ART

This disclosure relates to the field of intelligent data ingestion, normalization, and ontological mapping in situational awareness, decision-making, and visualization systems.

### BACKGROUND

In modern situational awareness and decision-support systems, large volumes of heterogeneous data are ingested from multiple sources, requiring rapid interpretation, standardization, and integration into meaningful structures. Traditional data normalization techniques often rely on static schema definitions, limiting their ability to manage diverse and evolving datasets. The need for real-time, adaptive data normalization is particularly critical in high-velocity domains such as cybersecurity, military operations, transportation, and healthcare.

Conventional data processing systems face significant challenges when attempting to integrate data from disparate sources with varying formats, structures, and semantic representations. Static schema-based approaches require manual configuration and reconfiguration as data sources evolve, creating bottlenecks in data ingestion pipelines and limiting system adaptability. Furthermore, traditional normalization processes often fail to account for contextual variations in data meaning and structure, resulting in semantic inconsistencies that compromise the quality of downstream analytics and decision-making.

Existing visualization systems for complex, multi-dimensional data typically rely on tabular displays or two-dimensional dashboards that require significant cognitive effort to interpret relationships between disparate data elements. These conventional approaches do not effectively leverage spatial cognition principles or provide intuitive mechanisms for exploring hierarchical data structures, resulting in increased cognitive load and slower decision-making processes in time-critical operational environments.

### BRIEF DESCRIPTION OF THE DRAWINGS

The disclosed embodiments have other advantages and features which will be more readily apparent from the detailed description, the appended claims, and the accompanying figures(or drawings). A brief introduction of the figures(FIGS.) is below.

FIG. 1 illustrates an adaptive data ingestion and mapping (ADIM) system configured to process heterogeneous data from multiple sources and transform it into a structured, ontology-aligned format in accordance with an example embodiment.

FIG. 2 illustrates the ADIM system including multiple interconnected components responsible for ingesting, processing, structuring, and storing heterogeneous data in accordance with an example embodiment.

FIG. 3 illustrates a deployment architecture showing the ADIM system designed to support hybrid deployment models across public cloud environments, private networks, and dedicated networks in accordance with an example embodiment.

FIG. 4 illustrates a computing device representing a physical or virtualized system executing the ADIM System in accordance with an example embodiment.

FIG. 5 illustrates the schemaless data ingestion engine enabling the ingestion and classification of diverse data sources without predefined schemas in accordance with an example embodiment.

FIG. 6 illustrates the semantic mapping module responsible for aligning incoming structured data with a predefined ontological framework in accordance with an example embodiment.

FIG. 7 illustrates the context-aware adaptive normalization module responsible for dynamically transforming ontology-aligned data into fully standardized and structured formats in accordance with an example embodiment.

FIG. 8 illustrates the high-velocity state change processor designed to detect, prioritize, and propagate real-time state changes across the ADIM system in accordance with an example embodiment.

FIG. 9 illustrates the graph-based data structuring engine processing incoming data into a format optimized for visualization in accordance with an example embodiment.

FIG. 10 illustrates a multi-layered spatial visualization model generated by the ADIM system, where each layer represents a distinct hierarchical layer of the data domain being analyzed in accordance with an example embodiment.

FIG. 11 illustrates a machine to read and execute computer readable instructions corresponding to the processes described herein in accordance with an example embodiment.

### DETAILED DESCRIPTION

The Figures(FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### CONFIGURATION SUMMARY

The disclosed configuration describes an adaptive data ingestion and mapping (ADIM) system, which ingests, maps, and standardizes heterogeneous data sources into a unified ontological framework. This process enables rapid adaptability to new data sources, real-time state change processing, and seamless integration with dynamic situational awareness visualizations including decision trees, such as those used in machine-teaming interactive decision systems (MIDS). The structured data output is dynamically mapped onto a hierarchical visualization model, allowing for the real-time rendering of abstracted decision layers. The visualization engine leverages structured ontological mappings to generate multi-layered, hierarchical visual representations, such as stacked spatial layers, important for users such as decision-making entities, security frameworks, and operational domains. This ensures that high-dimensional data can be visually explored in an intuitive manner. Additionally, the ADIM system enables contextual annotation and interaction mechanisms within the visualization. Users can navigate decision layers, highlight key risk factors, and analyze real-time state changes reflected within the visualization framework.

A system for adaptive data ingestion and mapping includes a schemaless data ingestion engine that receives and parses data from heterogeneous sources without requiring predefined schemas. The engine processes structured, semi-structured, and unstructured data formats and identifies entities, attributes, and relationships within the data. A semantic mapping module aligns the identified entities, attributes, and relationships with an ontological structure using rule-based processing, machine learning, and natural language processing to resolve semantic variations across different data sources. A context-aware adaptive normalization module refines and standardizes the semantically mapped data based on historical patterns, domain-specific rules, and real-time operational context, dynamically adjusting transformations in response to changes in the data. A state change processor detects changes in incoming data and applies differential updates to previously processed data, modifying only affected portions while maintaining computational efficiency. A graph-based data structuring engine organizes the normalized data into a graph format that establishes contextual relationships between entities and maps those relationships to visualization elements for presentation to decision-support systems.

In some embodiments, the schemaless data ingestion engine dynamically infers schema structure for previously unseen data formats using large language models. The engine may apply preprocessing operations including cleansing, tokenization, and formatting prior to schema inference. The semantic mapping module may be configured to propose updates to the ontological structure when novel entities or relationships are detected in incoming data, with such proposed updates including new entity classes, attribute refinements, or expanded relationship mappings for human review. The state change processor may compute differential updates between a current system state and incoming changes to selectively update only affected portions of structured data, with a prioritized update queue ranking updates based on contextual importance, urgency, and decision impact before propagation to downstream visualization elements.

The disclosed adaptive data ingestion and mapping (ADIM) system provides significant advantages over conventional data processing approaches by eliminating the need for manual schema configuration and enabling seamless integration of heterogeneous data sources. By leveraging schemaless data ingestion with large language model-based schema inference, the system can automatically process previously unseen data formats without requiring human intervention or system reconfiguration. This substantially reduces onboarding time for new data sources and eliminates bottlenecks associated with static schema-based approaches. The context-aware adaptive normalization module dynamically adjusts transformation logic based on historical patterns and real-time operational context, ensuring data consistency across evolving datasets without manual reconfiguration. The high-velocity state change processor further enhances system efficiency by applying differential updates that modify only affected data portions, significantly reducing computational overhead while maintaining real-time responsiveness in high-velocity operational environments.

The integration of graph-based data structuring with multi-layered spatial visualization provides substantial cognitive and operational benefits for decision-makers in complex domains. The system's hierarchical visualization framework transforms high-dimensional datasets into intuitive, interactive spatial representations that align with natural human perception and leverage memory palace cognitive principles. This approach reduces cognitive load and accelerates decision-making by enabling users to visually trace relationships across interconnected data layers, such as tracking security incidents from identity compromises through affected systems and network segments. The visualization framework is domain-agnostic and dynamically adapts the number and type of layers based on analytical requirements, supporting diverse applications including cybersecurity, military operations, healthcare, and financial risk assessment. By combining adaptive data normalization with cognitively optimized visualization, the ADIM system enables faster, more accurate decision-making in time-critical operational environments while maintaining compatibility with existing decision-support frameworks and external analytics tools.

### EXAMPLE ADAPTIVE DATA INGESTION AND MAPPING SYSTEM

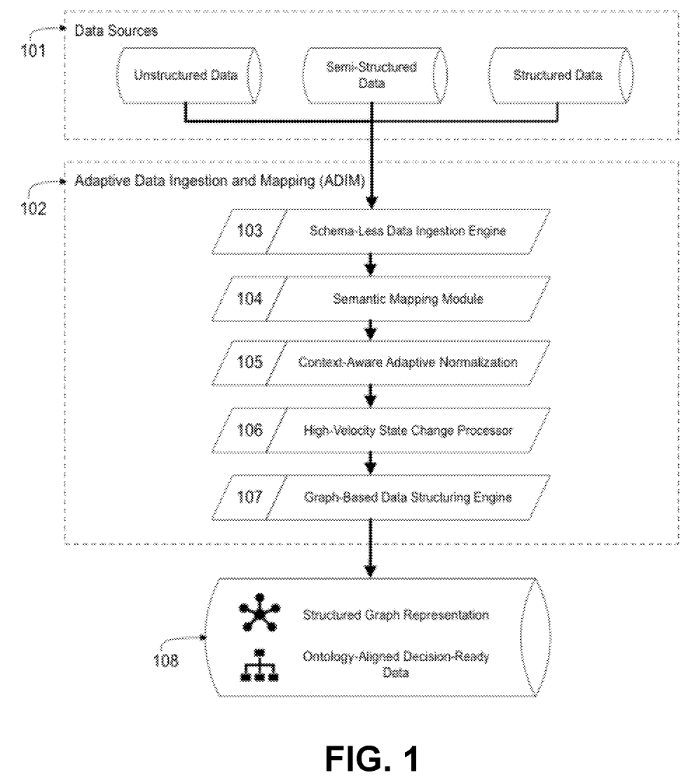

FIG. 1 illustrates an adaptive data ingestion and mapping (ADIM) system configured to process heterogeneous data from multiple sources and transform it into a structured, ontology-aligned format. As depicted in FIG. 1, the ADIM system 102 is configured to process heterogeneous data from multiple sources and transform it into a structured, ontology-aligned format. The ADIM system receives incoming structured, semi-structured, and unstructured data 101 from various sources and applies a sequential processing pipeline to normalize, structure, and optimize data for downstream decision-making applications.

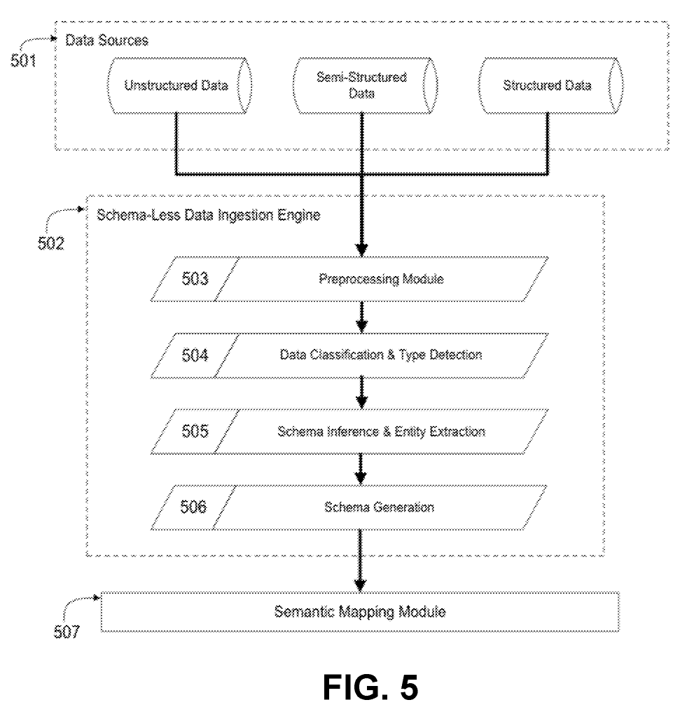

The schemaless data ingestion engine 103 is responsible for receiving and parsing data from multiple heterogeneous sources without requiring predefined schemas. This module enables the system to detect and process structured, semi-structured, and unstructured data formats, extracting key entities, attributes, and relationships for further transformation. By eliminating the need for manually configured schemas, the schemaless data ingestion engine enhances the adaptability of the ADIM system to new and evolving data formats. A detailed view of the schemaless data ingestion engine 103 is further illustrated in FIG. 5.

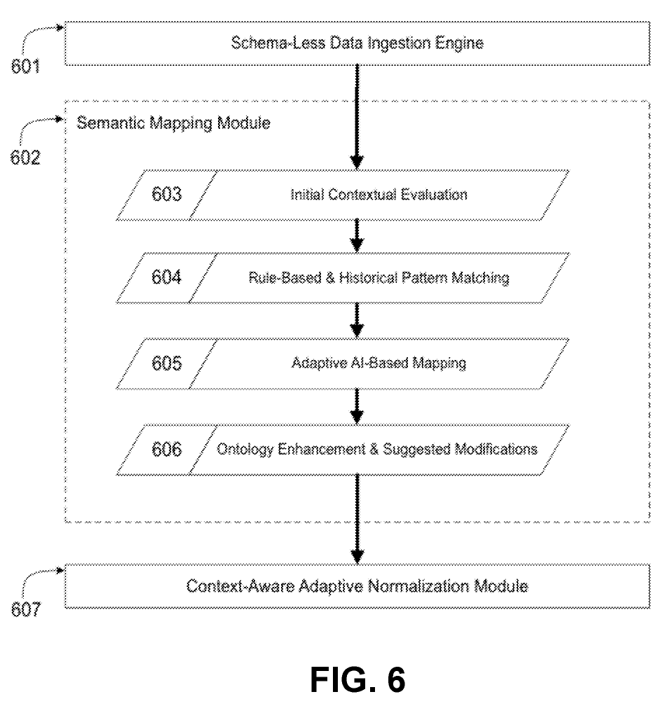

The semantic mapping module 104 processes the parsed data to align disparate data elements with a predefined ontological structure. This module determines whether processing, for example by machine learning (ML), is necessary before performing semantic alignment. If required, it assigns an appropriate processing tier to optimize performance. This module leverages machine learning models and natural language processing (NLP) techniques to identify contextual relationships, recognize equivalent entities, and resolve semantic discrepancies between different data sources. Additionally, if new data does not fit within the existing ontological structure, the module suggests updates for human review. A detailed view of the semantic mapping module 104 is further illustrated in FIG. 6.

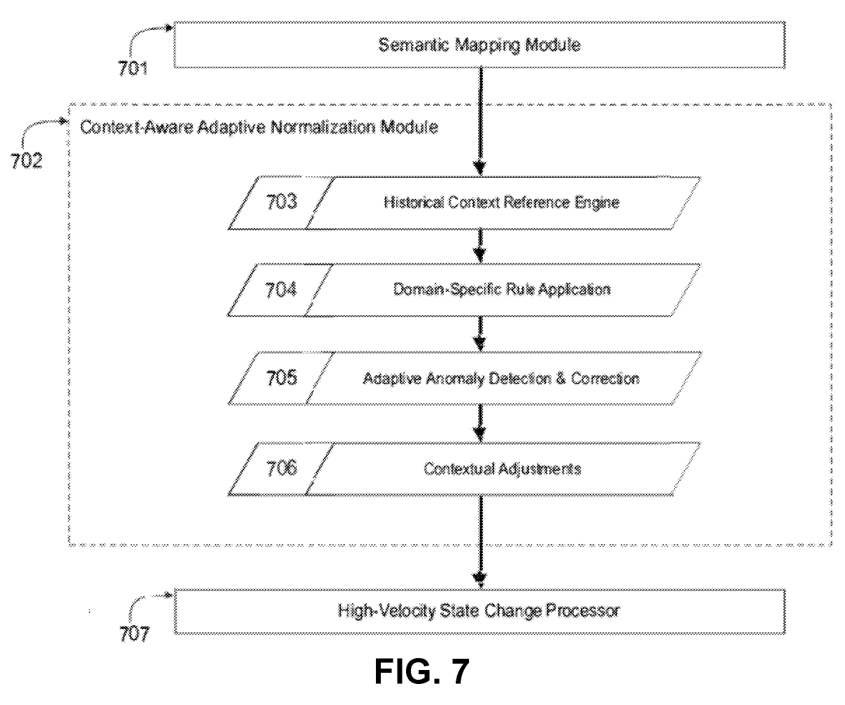

The context-aware adaptive normalization module 105 refines and standardizes the semantically mapped data by applying transformation rules based on historical patterns and real-time operational context. Unlike static normalization approaches, this module dynamically adjusts its transformations in response to changes in data structure and content, ensuring uniformity without requiring manual reconfiguration. The context-aware adaptive normalization module enables the ADIM system to manage evolving data schemas while maintaining compatibility with decision-support frameworks. A detailed view of the context-aware adaptive normalization module 105 is further illustrated in FIG. 7.

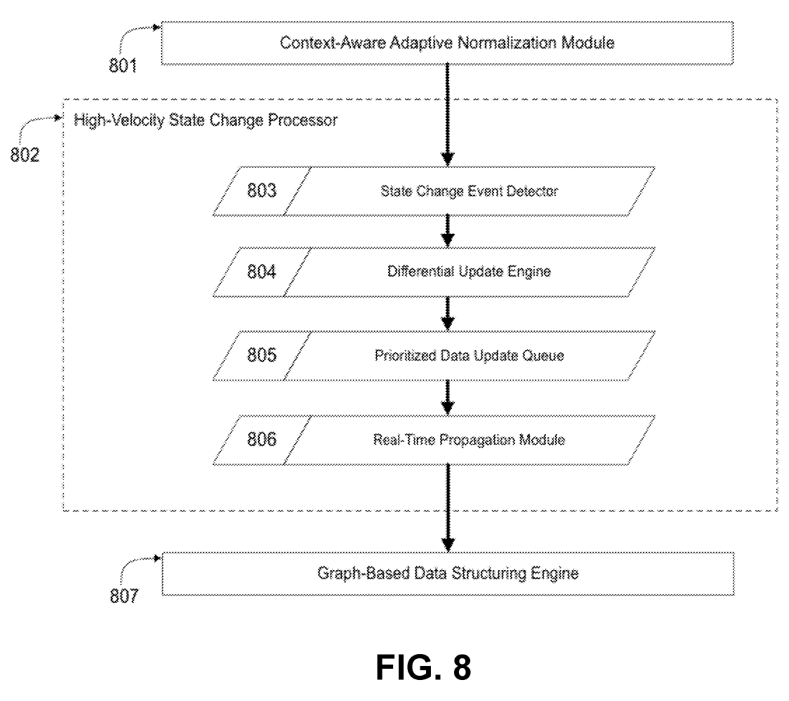

The high-velocity state change processor 106 is designed to detect updates in incoming data streams and selectively modify previously processed data without reprocessing the entire dataset. This module applies differential updates, ensuring that only affected portions of the structured data are modified while preserving computational efficiency. This module also focuses its operation on changes that impact decisions for a target audience, relative to their state, immediate context window, and future context windows. By reducing redundant processing and focusing on reprocessing that relates to the context of a given audience, the high-velocity state change processor enhances the responsiveness of real-time decision-making applications. A detailed view of the high-velocity state change processor 106 is further illustrated in FIG. 8.

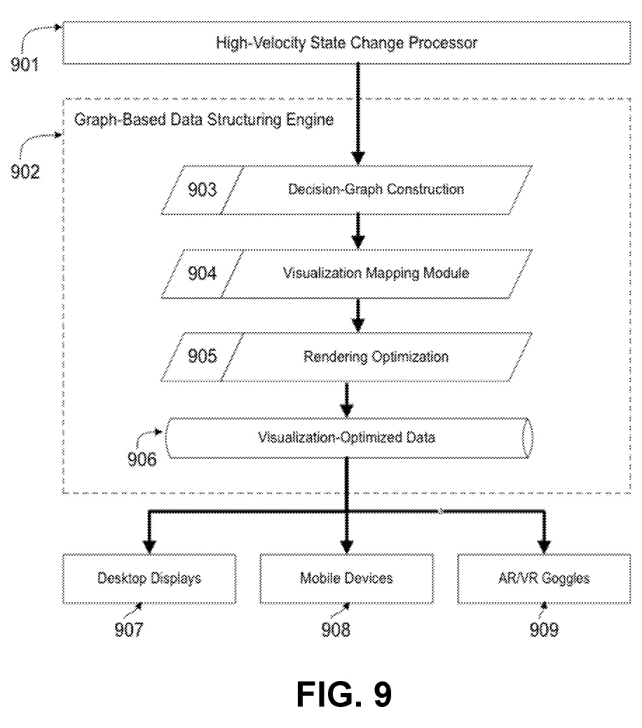

The graph-based data structuring engine 107 organizes the normalized data into a structured graph representation optimized for decision-making. This module establishes contextual relationships between entities, enabling efficient querying, knowledge inference, and integration with decision models, including artificial intelligence (AI)-powered decision models. By structuring data in an ontology-driven manner, the graph-based data structuring engine enhances data retrieval performance and ensures compatibility with decision-support frameworks such as machine-teaming interactive decision systems (MIDS). Additionally, this module maps structured data to front-end visualization elements, dynamically transforming hierarchical data into multi-dimensional spatial representations. The visualization engine interprets this structured data and renders interactive, layered informational models that visually represent key entities, relationships, and contextual states. Through an adaptive rendering pipeline, the system enables real-time updates to visual elements, ensuring that decision-makers can explore, analyze, and interact with complex data structures in an intuitive and immersive environment. A detailed view of the graph-based data structuring engine 107 is further illustrated in FIG. 9.

The system outputs structured graph representation 108 and ontology-aligned decision-ready data, providing a foundation for downstream decision-making applications and visualization systems.

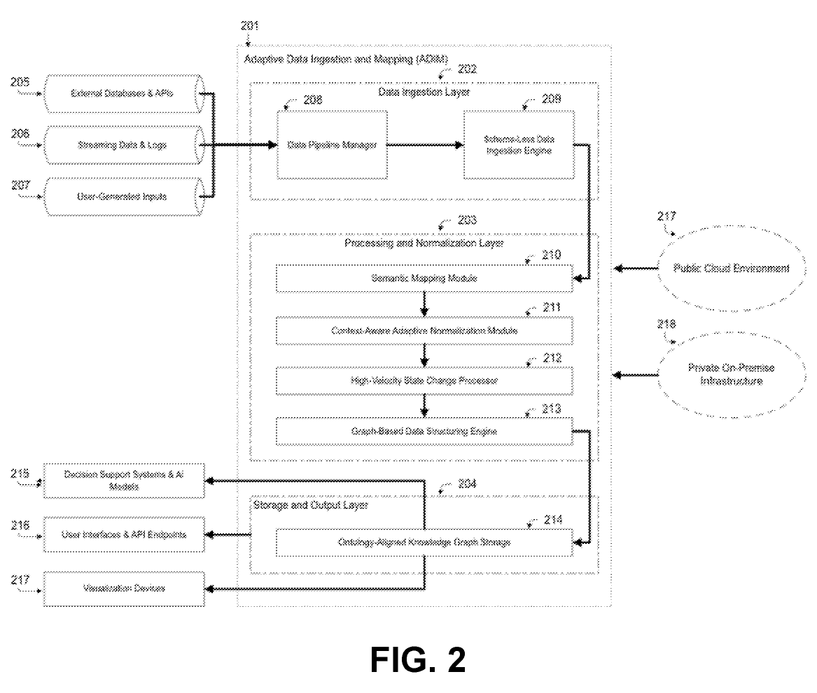

FIG. 2 illustrates the ADIM system including multiple interconnected components responsible for ingesting, processing, structuring, and storing heterogeneous data. As depicted in FIG. 2, the adaptive data ingestion and mapping (ADIM) system 201 includes multiple interconnected components responsible for ingesting, processing, structuring, and storing heterogeneous data. The system is designed to operate in a cloud-based, on-premises, or hybrid deployment, ensuring adaptability across different computing environments. The depicted ADIM system is but one example of a suitable implementation and is not intended to suggest any limitation as to the scope of use or functionality as disclosed herein.

The data ingestion layer 202 is responsible for retrieving data from multiple external sources, including external databases and application programming interfaces (APIs) 205, streaming data and logs 206, and user-generated inputs 207. The data pipeline manager 208 oversees data transfer and ensures integrity before passing it to the schemaless data ingestion engine 209, which processes the incoming data without requiring predefined schemas.

The processing and normalization layer 203 performs transformations to convert ingested raw data into a structured format. This layer includes the semantic mapping engine 210, context-aware adaptive normalization module 211, high-velocity state change processor 212, and graph-based data structuring engine 213. These components work in sequence to apply machine-learning-based semantic alignment, dynamic normalization, real-time data updates, and graph-based structuring to prepare data for storage and retrieval.

The storage and output layer 204 is responsible for storing the structured data in an indexed and queryable format. The ontology-aligned knowledge graph storage 214 houses the final structured representation and ensures it is available for retrieval. External applications interact with this data through decision support systems and AI models 215, user interfaces and API endpoints 216, and visualization devices 217 ensuring seamless integration with downstream analytics tools.

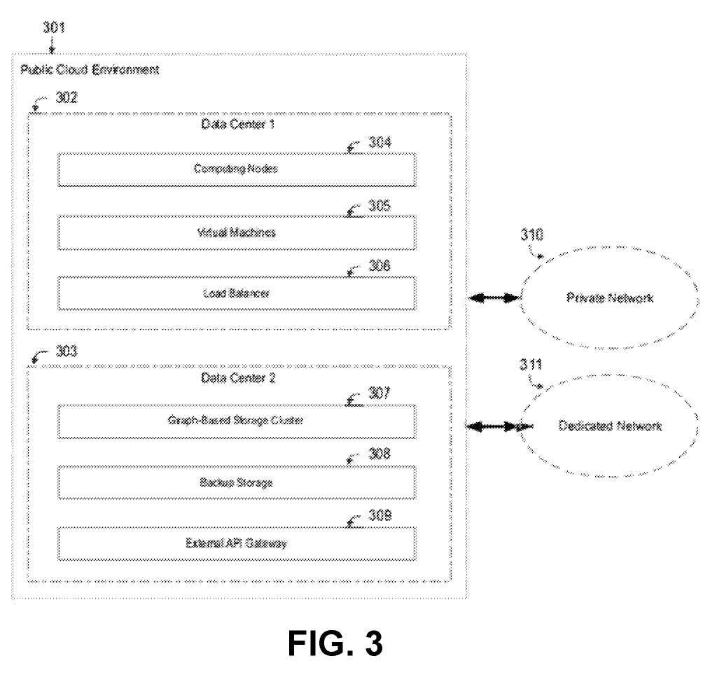

FIG. 3 illustrates a deployment architecture showing the ADIM system designed to support hybrid deployment models across public cloud environments, private networks, and dedicated networks. As depicted in FIG. 3, the ADIM system is designed to support hybrid deployment models, allowing interoperability between public cloud environment 301, private network 310, and dedicated network 311. The public cloud environment 301 consists of multiple data centers, including data center 1302 and data center 2303, which collectively manage data ingestion, processing, storage, and system-wide workload distribution. The deployment architecture supports the execution of the ADIM system components described in FIGS. 1 and 2 across distributed computing environments.

The system is designed to distribute workloads dynamically across multiple computing nodes 304 running within virtual machines 305. A load balancer 306 manages the distribution of tasks, optimizing resource utilization across the infrastructure. Data center 2 303 is responsible for storing processed data and managing redundancy. The graph-based storage cluster 307 houses structured, ontology-aligned decision-ready data, while backup storage 308 ensures data integrity and disaster recovery.

The external API gateway 309 provides a means for decision-support systems, visualization platforms, and external AI models to interact with ADIM through standardized API calls. The private network 310 represents an enterprise-hosted version of ADIM, while the dedicated network 311 accommodates specialized implementations within secure environments, such as a government or military network.

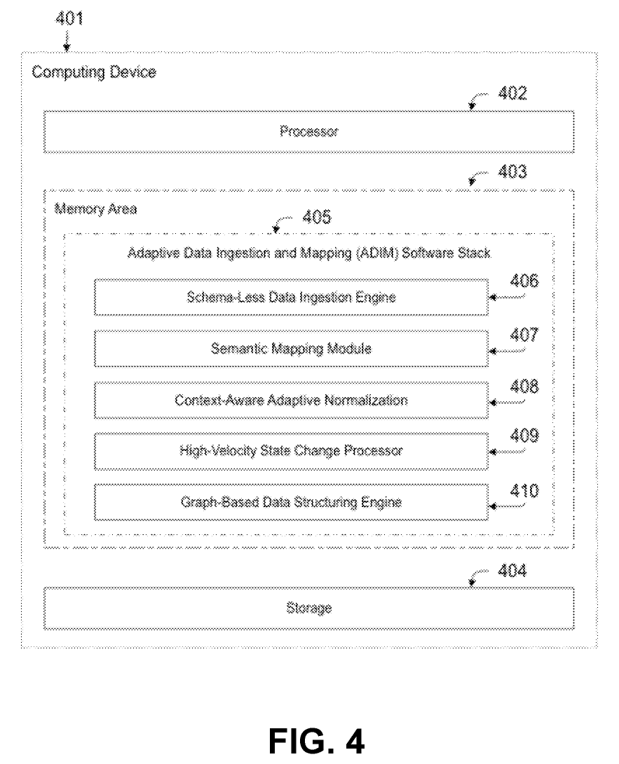

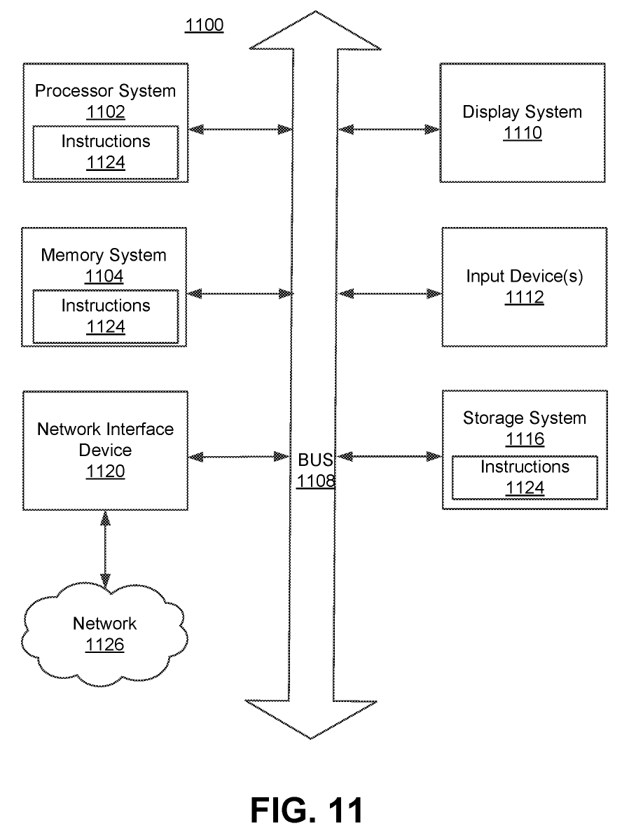

FIG. 4 illustrates a computing device representing a physical or virtualized system executing the ADIM System. As depicted in FIG. 4, the computing device 401 represents a physical or virtualized system executing the adaptive data ingestion and mapping (ADIM) system. This computing device includes core hardware components, including a processor 402, memory area 403, and storage 404. These elements collectively enable the execution, processing, and storage of ADIM operations. The depicted computing architecture is but one example of a suitable implementation and is not intended to suggest any limitation as to the scope of use or functionality of the disclosed configurations. The computing device 401 may be similar to the machine, e.g., computer system 1100 described with FIG. 11. In addition, the processor 402 may be part of the processor system 1102, the memory area may be part of the memory system 1104, and the storage 404 may be part of the storage system 1116 described in FIG. 11.

The memory area 403 houses the adaptive data ingestion and mapping software stack 405, which consists of multiple processing modules responsible for ingesting, normalizing, structuring, and updating data in real-time. The modules include schemaless data ingestion engine 406, semantic mapping 407, context-aware adaptive normalization 408, high-velocity state change processor 409, and graph-based data structuring engine 410. These components work in sequence to process incoming raw data, apply semantic and contextual transformations, and generate a structured knowledge representation. These modules correspond to the functional components illustrated in FIG. 1, with the schemaless data ingestion engine 406 corresponding to element 103, the semantic mapping 407 corresponding to element 104, the context-aware adaptive normalization 408 corresponding to element 105, the high-velocity state change processor 409 corresponding to element 106, and the graph-based data structuring engine 410 corresponding to element 107.

The adaptive data ingestion and mapping software stack 405 is designed to operate efficiently within the memory area 403, ensuring high-performance processing and minimal latency. The schemaless data ingestion engine 406 enables flexible data ingestion without predefined schemas, while the semantic mapping 407 aligns data to an ontological structure. The context-aware adaptive normalization 408 dynamically formats data based on domain context, and the high-velocity state change processor 409 ensures real-time updates. The graph-based data structuring engine 410 transforms the processed data into a structured knowledge graph with mapped visualization elements for decision-making applications and visualization platforms.

### EXAMPLE SCHEMALESS DATA INGESTION ENGINE

FIG. 5 illustrates the schemaless data ingestion engine enabling the ingestion and classification of diverse data sources without predefined schemas. As depicted in FIG. 5, the schemaless data ingestion engine 502 enables the ingestion and classification of diverse data sources without predefined schemas, allowing the system to process structured, semi-structured, and unstructured data formats dynamically. The schemaless data ingestion engine 502 corresponds to the schemaless data ingestion engine 103 described in FIG. 1 and the schemaless data ingestion engine 209 described in FIG. 2. The raw data sources 501 may include structured data sources, for example, relational databases and CSV files, semi-structured data such as JSON, XML, and logs, and unstructured data from text documents, messages, and sensor outputs.

Incoming data is first processed by the preprocessing module 503, which applies data cleansing, tokenization, and formatting to ensure consistency. The data classification and type detection module 504 then evaluates the input format, distinguishing between structured, semi-structured, and unstructured data types, and assigns each dataset to an appropriate processing workflow.

If the data lacks an explicit schema or does not conform to known formats, it is processed by the schema inference and entity extraction module 505. This module leverages large language models (LLMs) to dynamically infer schema structure, extract key entities, and identify relationships within the data. Additionally, contextual metadata is analyzed to improve alignment with historical ingestion patterns.

For previously unseen data formats, the schema generation module 506 dynamically constructs inferred schemas, using historical ingestion data and contextual awareness to refine its schema evolution over time. Once schema inference and entity extraction are complete, the processed data is forwarded to the semantic mapping module 507 for further transformation and ontology alignment. The semantic mapping module 507 corresponds to the semantic mapping module 104 described in FIG. 1 and is further detailed in FIG. 6.

By leveraging LLMs for schema inference and adaptive entity extraction, the schemaless data ingestion engine 502 ensures that the system can ingest, structure, and classify previously unseen data without requiring manual schema definition, significantly improving adaptability, and reducing onboarding time for new data sources. The modular pipeline structure ensures seamless integration with downstream semantic mapping and normalization processes, enabling the broader adaptive data ingestion and mapping (ADIM) framework to continuously evolve in response to new data domains.

### EXAMPLE SEMANTIC MAPPING MODULE

FIG. 6 illustrates the semantic mapping module responsible for aligning incoming structured data with a predefined ontological framework. As depicted in FIG. 6, the semantic mapping module 602 is responsible for aligning incoming structured data with a predefined ontological framework, ensuring semantic consistency and context-aware integration. The semantic mapping module 602 corresponds to the semantic mapping module 104 described in FIG. 1 and the semantic mapping engine 210 described in FIG. 2. The module receives input from the schemaless data ingestion engine 601, which has already classified and structured the data but has not yet mapped it to an ontological structure. The schemaless data ingestion engine 601 corresponds to the schemaless data ingestion engine 103 described in FIG. 1 and is detailed in FIG. 5.

The initial contextual evaluation module 603 assesses whether semantic mapping is required. If the incoming data closely aligns with an existing ontological model, it applies minimal transformations to optimize computational efficiency. If discrepancies exist, the data proceeds through further rule-based or AI-driven transformations.

The rule-based and historical pattern matching module 604 applies predefined heuristics and historical mappings to recognize entities, relationships, and data structures. If the data can be mapped using previously established rules, the system aligns it without requiring AI intervention.

If rule-based mapping fails or the data presents substantial structural variations, the adaptive AI-based mapping module 605 is engaged. This module employs LLMs (large language models) to analyze semantic relationships, contextual dependencies, and multi-source correlation factors. The AI dynamically categorizes entities, maps relationships, and ensures semantic integrity, making real-time adjustments to align data with the ontology.

In cases where the system detects novel entity types or relationships that do not fit the existing ontology, the ontology enhancement, and suggested modifications module 606 provides proposed updates for human review. These may include new entity classes, attribute refinements, or expanded relationship mappings, ensuring that the ontology remains adaptive and scalable to evolving data domains.

The final output consists of fully mapped and structured data, which is forwarded to the context-aware adaptive normalization module 607 for further refinement. The context-aware adaptive normalization module 607 corresponds to the context-aware adaptive normalization module 105 described in FIG. 1 and is further detailed in FIG. 7. This architecture ensures scalable, efficient, and adaptive semantic mapping, and can optimize performance based on contextual requirements.

### EXAMPLE CONTEXT-AWARE ADAPTIVE NORMALIZATION MODULE

FIG. 7 illustrates the context-aware adaptive normalization module responsible for dynamically transforming ontology-aligned data into fully standardized and structured formats. As depicted in FIG. 7, the context-aware adaptive normalization module 702 is responsible for dynamically transforming ontology-aligned data into fully standardized and structured formats, ensuring consistency and contextual accuracy. The context-aware adaptive normalization module 702 corresponds to the context-aware adaptive normalization module 105 described in FIG. 1 and the context-aware adaptive normalization module 211 described in FIG. 2.

The module receives input from the semantic mapping module 701, which provides structured data mapped to an ontological framework. The semantic mapping module 701 corresponds to the semantic mapping module 104 described in FIG. 1 and is detailed in FIG. 6. However, variations in format, metadata, and structural consistency may still exist, requiring further context-driven transformations.

The historical context reference engine 703 maintains a repository of prior normalization patterns, tracking how similar data points were previously processed. By leveraging pattern recognition and statistical modeling, the system determines the optimal transformation strategies for incoming data.

The domain-specific rule application module 704 enforces industry, operational, or domain-specific normalization rules, ensuring compliance with internal standards, external regulations, and system-wide best practices. These rules may be manually defined, AI-derived, or historically inferred from past transformations.

The adaptive anomaly detection & correction module 705 identifies data inconsistencies, missing attributes, anomalies, or unexpected variations. Using ML-based models and predefined heuristics, the system determines whether data elements require automated corrections, enrichment, or human validation.

The contextual adjustments module 706 dynamically modifies normalization strategies based on current operational needs, evolving user inputs, and external environmental changes. The system integrates feedback from decision-support models and prior normalization actions to refine its approach.

The fully normalized output is sent to the high-velocity state change processor 707 for real-time state updates. The high-velocity state change processor 707 corresponds to the high-velocity state change processor 106 described in FIG. 1 and is further detailed in FIG. 8. By ensuring adaptive, intelligent, and context-aware normalization, this module enhances data quality, reduces inconsistencies, and ensures seamless integration across all downstream decision-making and visualization processes.

### EXAMPLE PROCESSING ENGINES

FIG. 8 illustrates the high-velocity state change processor designed to detect, prioritize, and propagate real-time state changes across the ADIM system. As depicted in FIG. 8, the high-velocity state change processor 802 receives input from the context-aware adaptive normalization module 801 and is designed to detect, prioritize, and propagate real-time state changes across the adaptive data ingestion and mapping (ADIM) system. The high-velocity state change processor 802 corresponds to the high-velocity state change processor 106 described in FIG. 1 and the high- velocity state change processor 212 described in FIG. 2. The context-aware adaptive normalization module 801 corresponds to the context-aware adaptive normalization module 105 described in FIG. 1 and is detailed in FIG. 7. This module ensures that only the necessary updates are processed, significantly reducing computational overhead and improving system responsiveness.

The state change event detector 803 continuously monitors incoming data for modifications, new entries, deletions, and structural adjustments. Using event-driven architecture, this module can rapidly detect changes and classify them based on urgency and importance. Once a change is detected, the differential update engine 804 computes delta changes between the current system state and the incoming updates. This allows the system to update only affected data points, avoiding the need for full dataset reprocessing. To optimize processing efficiency, the prioritized data update queue 805 ranks updates based on impact, urgency, and contextual importance. This ensures that critical updates are managed immediately, while lower-priority updates can be processed in batch mode to conserve resources.

The real-time propagation module 806 ensures that all validated updates are efficiently distributed to downstream processing layers, including decision-support models, analytics engines, and visualization frameworks. This module leverages asynchronous messaging and event-based communication to propagate state changes without performance bottlenecks.

The processed updates are sent to the graph-based data structuring engine 807, which integrates the latest state modifications into the system's structured decision-making model. The graph-based data structuring engine 807 corresponds to the graph-based data structuring engine 107 described in FIG. 1 and is further detailed in FIG. 9. This enables real-time adjustments to ontology-driven knowledge graphs and visualization layers. By optimizing the processing and distribution of state changes, this module significantly enhances the real-time adaptability of the ADIM system, ensuring that users and connected applications always operate on the most up-to-date and accurate data.

FIG. 9 illustrates the graph-based data structuring engine processing incoming data into a format optimized for visualization. As depicted in FIG. 9, the high-velocity state change processor 901 provides real-time structured updates to the graph-based data structuring engine (GBDSE) 902, which processes the incoming data into a format optimized for visualization. The high-velocity state change processor 901 corresponds to the high-velocity state change processor 106 described in FIG. 1 and is detailed in FIG. 8. The GBDSE 902 corresponds to the graph-based data structuring engine 107 described in FIG. 1 and the graph-based data structuring engine 213 described in FIG. 2. Within the GBDSE 902, the incoming data is processed through multiple stages to create a structured and visually representable format.

The decision-graph construction module 903 establishes structured relationships between entities and decision pathways, transforming raw data into an interconnected, query-efficient representation. The processed graph-based data is then passed to the visualization mapping module 904, which translates the decision graph into hierarchical spatial representations that define how information is visually organized. Once mapped, the visualization-optimized data 906 is generated, encapsulating the structured visualization layers, spatial mappings, and rendering configurations needed for visualization output.

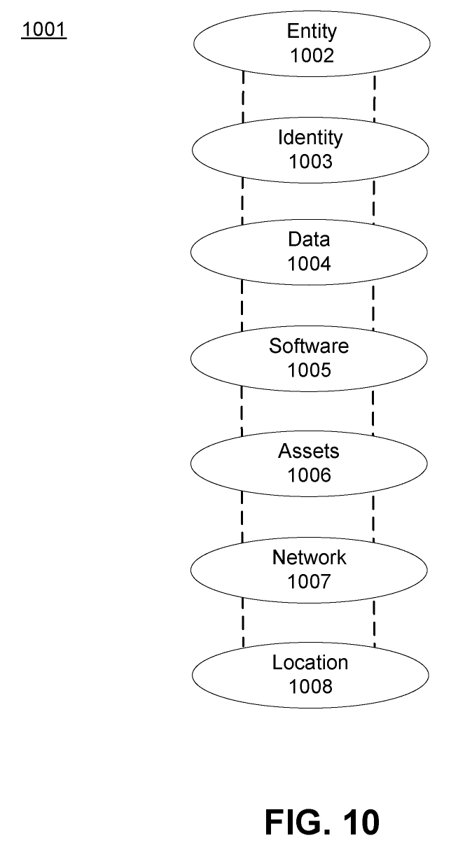

The rendering optimization module 905 further processes the visualization-optimized data 906 to ensure efficient rendering across multiple display environments. The final structured visualization output is then transmitted to desktop displays 907, mobile devices 908, and AR/VR goggles 909, allowing users to interact with dynamic, multi-layered decision visualizations. The visualization output is adaptable to different domains and decision-making contexts, ensuring that the structured representation remains flexible and scalable. By structuring data in a graph-based format and optimizing it for interactive visualization, the ADIM system enhances situational awareness, reduces cognitive load, and enables rapid decision-making in complex operational environments. An example of the multi-layered visualization output is illustrated in FIG. 10.

### EXAMPLE MULTI-LAYERED SPATIAL VISUALIZATION MODEL

FIG. 10 illustrates a multi-layered spatial visualization model generated by the ADIM system, where each layer represents a distinct hierarchical layer of the data domain being analyzed. As depicted in FIG. 10, the adaptive data ingestion and mapping (ADIM) system generates visualizations that vary based on the context and use case. In appropriate use cases, the ADIM will generate a multi-layered spatial visualization model, where each "platter" represents a distinct hierarchical layer of the data domain being analyzed. This visualization represents the output of the graph-based data structuring engine described in FIG. 9. In the illustrated example, the visualization is applied to the cybersecurity domain and consists of seven layers: entities layer 1002, identity layer 1003, data layer 1004, software layer 1005, assets layer 1006, network layer 1007, and location layer 1008. Each layer spatially organizes relevant data points, enabling users to explore the relationships between different security elements within the system. The hierarchical stacking of these layers allows decision-makers to intuitively assess interdependencies, detect anomalies, and quickly derive actionable insights from the data. In certain use cases, the ADIM may generate multiple platter stacks or other context-appropriate visualizations, in each case, these visualizations will enable users to intuitively assess interdependencies, detect anomalies, and quickly derive actionable insights from the data.

The spatialized representation of data in FIG. 10 improves cognitive efficiency by structuring complex datasets in a way that aligns with natural human perception. Traditional methods often rely on tabular or linear dashboard-based displays, requiring significant cognitive effort to correlate disparate data points. By contrast, the layered visualization model presents the data in an interactive, three-dimensional hierarchy, allowing users to visually track how entities in one layer connect to corresponding elements in other layers. For example, an analyst investigating an identity-related security incident in the identity layer 1003 can seamlessly trace its impact through the data layer 1004, software layer 1005, and network layer 1007 to identify affected systems and compromised network segments. This structured approach enhances situational awareness and reduces the time required to make informed decisions.

While FIG. 10 illustrates an example for a cybersecurity-specific visualization, the ADIM system is designed to dynamically adapt the number and type of layers based on the data domain and analytical requirements. The number of layers is not limited to seven, there can be multiple stacks of layers, branches or other visual representation which can be customized to fit different applications, including military operations, logistics, healthcare, and financial risk assessment. By spatializing data in a hierarchical and structured manner, the visualization framework transforms complex, high-dimensional datasets into an intuitive, interactive format. This methodology enhances the speed, accuracy, and efficiency of decision-making processes, ensuring that users can engage with and interpret data in a way that is both contextually meaningful and cognitively efficient.

The ADIM system supports advanced data annotation capabilities designed for higher-dimensional display environments. The graph-based decision structuring engine (GBDSE) facilitates a data annotation process wherein data points, insights, and decision pathways are captured, structured, and visualized to enhance comprehension and decision-making. Annotations can be reviewed, replayed, and analyzed in alternative two-dimensional (2D) formats and non- high-dimensional viewers, ensuring accessibility across various display environments. Multiple viewing audiences are enabled to interact with the annotations either synchronously, in a shared decision-making experience, or asynchronously, with independent control over playback, filtering, and exploration.

Annotated insights and decisions are stored and structured in standardized formats, allowing seamless integration with external systems, analytical tools, and archival repositories. Recorded annotations may be formatted and played back as a continuous video stream, thereby enabling structured visualization of decision sequences akin to a cinematic experience. Alternatively, recorded annotations may be presented in a segmented, slide-based, deck-like, or stepwise format, augmented with multimedia elements such as images, audio, and dynamic overlays to enhance clarity and retention. Annotations and decision records are aligned with established audit trail requirements, reporting standards, and compliance frameworks to ensure verifiable tracking and regulatory adherence.

The ADIM system supports a bonsai-inspired branching visualization framework for decision augmentation, generated dynamically using the graph-based decision structuring engine (GBDSE). Hierarchical decision pathways and risk factors are represented with a compact and intuitive layout. The bonsai branching visualization enhances decision-making by providing direct comparisons of risk models, enabling analysts to evaluate trade-offs, uncertainties, and outcome probabilities across multiple branches. Decision models represented in bonsai branching format may be specifically applied to domain-specific decision analysis and strategic assessments, including the nine domains of military operations.

The ADIM system incorporates spatial data representation structured based on the cognitive psychology principles of the memory palace method, as implemented through the graph- based decision structuring engine (GBDSE). This approach enables users to spatially organize and recall complex information with greater efficiency. The spatial data representation is dynamically personalized, incorporating adaptive setup processes and ongoing learning to optimize memorability, decision-making speed, perceptual clarity, recognition accuracy, and communication effectiveness. The spatial data representation leverages the method of loci, arranging key decision points, relationships, and contextual markers along a structured mental framework to enhance cognitive processing, recall, and intuitive reasoning. The memory palace and method of loci (MoL+MP) techniques are enhanced by identifying both generalizable and user-specific inflection points, ensuring that cognitive acceleration benefits are maximized for each individual user's operational needs.

The combination of the memory palace (MP) and method of loci (MoL) cognitive models is utilized to enhance user cognition in the analysis and comparison of decision tree branches or other visualizations generated through the graph-based decision structuring engine (GBDSE), facilitating rapid understanding and improved decision accuracy.

The ADIM system ensures that data representations are formatted and structured for compatibility with industry-standard and proprietary data representation frameworks, ensuring interoperability across platforms. Data representations may be adapted into proprietary visualization, reporting, or analytical formats, allowing seamless integration into specialized software ecosystems. High-dimensional data may be selectively de-dimensionalized through mathematical projections, optimized to enhance readability, accelerate decision-making, and improve memory retention, with the transformation tailored to the specific cognitive and operational context in which the data will be utilized.

The ADIM system supports the generation of semasiologic symbols from decision structures. Structured data representations are leveraged as training data inputs for advanced contextual analysis, enabling the identification of latent concept loci and the generation of semasiologic symbols, forming the basis of a meta-language that encodes complex decision-making insights. Semasiologic symbols may be inferred based on common-knowledge narratives, storytelling structures, archetypal tropes, and culturally recognized motifs, ensuring that symbol meanings align with human cognitive and linguistic intuitions. The inferred narrative components are algorithmically selected based on their optimal alignment with the cognitive preferences, background knowledge, and situational awareness of the intended human user, thereby enhancing comprehension and contextual relevance. An image generation model may be employed to construct visual representations of semasiologic symbols, using common imagery and operational norms to facilitate intuitive communication of complex symbolic meanings. AI-driven large language models (LLMs) incorporating latent concept modeling (LCM), multimodal learning, and symbolic reasoning techniques are applied to identify semasiologic symbols and map them to human-interpretable semantic structures.

The ADIM system supports the encapsulation of data representations into structured data cards. Each data card defines a bounded quantization of information, wherein the encapsulation boundaries are determined based on inference-driven learning, domain-specific frameworks, or predefined structuring methodologies. Data cards incorporate derived meta-language constructs, including semasiologic symbols, to establish a standardized yet adaptable knowledge representation framework. Data cards are designed as fully portable, self-contained archival records, allowing independent analysis, review, and integration into external decision-support systems.

The ADIM system supports the construction of a dynamic context model based on user interactions and learned behavioral patterns. The context model serves as a structured knowledge framework for automating and controlling intelligent devices, robotic platforms, and cybernetic systems. The context model may be further utilized by automated or semi-autonomous systems to communicate decision-making insights to human operators through the use of semasiologic symbols and structured data cards, thereby facilitating machine-teaming interactive decisions (MIDS) that enhance collaborative human-machine workflows.

### EXAMPLE MACHINE ARCHITECTURE

Turning now to FIG. 11, illustrated is an example machine to read and execute computer readable instructions corresponding to the processes described herein in accordance with an embodiment. Specifically, FIG. 11 shows a diagrammatic representation of the data processing service (and/or data processing system) in the example form of a computer system 1100. The computer system 1100 is structured and configured to operate through one or more other systems (or subsystems) as described herein. The computer system 1100 can be used to execute instructions 1124 (e.g., program code or software) for causing the machine (or some or all of the components thereof) to perform any one or more of the methodologies (or processes) described herein. In executing the instructions, the computer system 1100 operates in a specific manner as per the functionality described. The computer system 1100 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 1100 may be a server computer, a client computer, a personal computer (PC), a tablet PC, a smartphone, an internet of things (IoT) appliance, a network router, switch or bridge, or other machine capable of executing instructions 1124 (sequential or otherwise) that enable actions as set forth by the instructions 1124. Further, while only a single machine is illustrated, the term “machine” shall also be taken to include any collection of machines that individually or jointly execute instructions 1124 to perform any one or more of the methodologies discussed herein.

The example computer system 1100 includes a processor system 1102. The processor system 1102 includes one or more processors. The processor system 1102 may include, for example, a central processing unit (CPU), a graphics processing unit (GPU), neural processing unit (NPU), a tensor processing unit (TPU), a digital signal processor (DSP), a controller, a state machine, one or more application specific integrated circuits (ASICs), one or more radio-frequency integrated circuits (RFICs), or any combination of these. The processor system 1102 executes an operating system for the computing system 1100. The computer system 1100 also includes a memory system 1104. The memory system 1104 may include or more memories (e.g., dynamic random access memory (RAM), static RAM, cache memory). The computer system 1100 may include a storage system 1116 that includes one or more machine readable storage devices (e.g., magnetic disk drive, optical disk drive, solid state memory disk drive).

The storage system 1116 stores instructions 1124 (e.g., software) embodying any one or more of the methodologies or functions described herein. For example, the instructions 1124 may include instructions to perform the functional operation of the processes described with FIGS. 1-10. The instructions 1124 may also reside, completely or at least partially, within the memory system 1104 or within the processing system 1102 (e.g., within a processor cache memory) during execution thereof by the computer system 1100, the main system 1104 and the processor system 1102 also constituting machine-readable media. The instructions 1124 may be transmitted or received over a network 1126, such as the network 1126, via the network interface system 1120.

The storage system 1116 should be taken to include a single medium or multiple media (e.g., a centralized or distributed database, or associated caches and servers communicatively coupled through the network interface system 1120) able to store the instructions 1124. The term “machine-readable medium” shall also be taken to include any medium that is capable of storing instructions 1124 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 1100 can include a display system 1110. The display system 1110 may driver firmware (or code) to enable rendering on one or more visual devices, e.g., drive a plasma display panel (PDP), a liquid crystal display (LCD), or a projector. The computer system 1100 also may include one or more input/output systems 1112. The input/output (IO) systems 1112 may include input devices (e.g., a keyboard, mouse (or trackpad), a pen (or stylus), microphone) or output devices (e.g., a speaker). The computer system 1100 also may include a network interface system 1120. The network interface system 1120 may include one or more network devices that are configured to communicate with an external network 1126. The external network 1126 may be a wired (e.g., ethernet) or wireless (e.g., WiFi, BLUETOOTH, near field communication (NFC).

The processor system 1102, the memory system 1104, the storage system 1116, the display system 1110, the IO systems 1112, and the network interface system 1120 are communicatively coupled via a computing bus 1108.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for the systems and processes described through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

What is claimed is:

1. A system for adaptive data ingestion and mapping, comprising:
a schemaless data ingestion engine configured to receive and parse data from heterogeneous sources without requiring predefined schemas, the engine operable to process structured, semi-structured, and unstructured formats and to identify entities, attributes, and relationships;
a semantic mapping module configured to align said entities, attributes, and relationships with an ontological structure, the module operable to use rule-based processing, machine learning, and natural language processing to resolve semantic variations across sources;
a context-aware adaptive normalization module configured to refine and standardize semantically mapped data based on historical patterns, domain-specific rules, and real-time operational context, the module operable to adjust its transformations dynamically in response to changes in data;
a state change processor configured to detect changes in incoming data and apply differential updates to previously processed data, modifying only affected portions while maintaining computational efficiency; and
a graph-based data structuring engine configured to organize normalized data into a graph format establishing contextual relationships between entities and mapping said relationships to visualization elements for presentation to decision-support systems.

2. The system of claim 1, wherein the schemaless data ingestion engine is further configured to dynamically infer schema structure for previously unseen data formats using large language models (LLMs).

3. The system of claim 2, wherein the schemaless data ingestion engine applies preprocessing including at least one of cleansing, tokenization, and formatting prior to schema inference.

4. The system of claim 1, wherein the semantic mapping module is configured to propose updates to the ontological structure when novel entities or relationships are detected in incoming data.

5. The system of claim 4, wherein such proposed updates include at least one of new entity classes, attribute refinements, and expanded relationship mappings for human review.

6. The system of claim 1, wherein the state change processor computes differential updates between a current system state and incoming changes to selectively update only affected portions of structured data, and wherein a prioritized update queue ranks said updates based on contextual importance, urgency, and decision impact before propagation to downstream visualization elements.

7. A method for adaptive data ingestion and mapping, comprising:
receiving and parsing data from heterogeneous sources without requiring predefined schemas, wherein the data comprises structured, semi-structured, and unstructured formats;
identifying entities, attributes, and relationships within the parsed data;
aligning the entities, attributes, and relationships with an ontological structure using rule-based processing, machine learning, and natural language processing to resolve semantic variations across sources;
refining and standardizing the aligned data based on historical patterns, domain-specific rules, and real-time operational context, wherein transformations are adjusted dynamically in response to changes in data;
detecting changes in incoming data and applying differential updates to previously processed data, modifying only affected portions while maintaining computational efficiency;
organizing normalized data into a graph format establishing contextual relationships between entities; and
mapping said relationships to visualization elements for presentation to decision-support systems.

8. The method of claim 7, wherein receiving and parsing the heterogeneous data further comprises dynamically inferring schema structures for previously unseen formats using large language models.

9. The method of claim 8, wherein parsing includes applying preprocessing operations including, before schema inference, at least one of data cleansing, tokenization, and formatting.

10. The method of claim 7, wherein aligning the identified entities, attributes, and relationships with the ontological structure further comprises proposing updates to said ontological structure when the data contains novel entities or relationships.

11. The method of claim 10, wherein proposed updates for review and integration into the ontological structure includes at least one of new entity classes, attribute refinements, or expanded relationship mappings.

12. The method of claim 7, wherein detecting changes in incoming data further comprises ranking detected changes in a prioritized update queue based on contextual importance, urgency, and decision impact.

13. The method of claim 12, wherein applying differential updates comprises propagating prioritized updates to visualization elements to enable real-time reflection of state changes in decision-support systems.

14. A non-transitory computer-readable medium comprising stored instructions, the instruction comprising instructions that when executed by a processor system, cause the processor system to:
receive and parse heterogeneous data from multiple sources without requiring predefined schemas, the data including structured, semi-structured, and unstructured formats;
identify entities, attributes, and relationships within the parsed data;
align the identified entities, attributes, and relationships with an ontological structure using rule-based processing, machine learning, and natural language processing to resolve semantic variations across sources;
refine and standardize the aligned data based on historical patterns, domain-specific rules, and real-time operational context, with transformations adjusted dynamically in response to changes in the data structure or content;
detect changes in incoming data and apply differential updates to previously processed data, modifying only affected portions while maintaining computational efficiency;
organize normalized data into a graph-based representation establishing contextual relationships between entities; and
map said relationships to visualization elements for presentation to decision-support systems.

15. The non-transitory computer-readable medium of claim 14, further comprising instructions that when executed cause the processor system to dynamically infer schema structures for previously unseen formats using large language models.

16. The non-transitory computer-readable medium of claim 15, further comprising instructions that when executed cause the processor system to apply preprocessing operations before schema inference using at least one of data cleansing, tokenization, and formatting.

17. The non-transitory computer-readable medium of claim 14, further comprising instructions that when executed cause the processor system to propose updates to the ontological structure when novel entities or relationships are detected in incoming data.

18. The non-transitory computer-readable medium of claim 17, further comprising instructions that when executed cause the processor system to provide proposed updates, the proposed updates for review and integration into the ontological structure using at least one of new entity classes, attribute refinements, and expanded relationship mappings.

19. The non-transitory computer-readable medium of claim 14, further comprising instructions that when executed cause the processor system to rank detected changes in a prioritized update queue based on contextual importance, urgency, and decision impact.

20. The non-transitory computer-readable medium of claim 19, further comprising instructions that when executed cause the processor system to propagate prioritized updates to visualization elements to enable real-time reflection of state changes in decision-support systems.
